(19) United States
(12) Patent Application Publication
(10) Pub. No.: US 2008/0261558 A1
(43) Pub. Date: Oct. 23, 2008

(54) System and Method for Transferring Credit Between Mobile Phone Subscribers

(75) Inventor: Eugenio Donato Renato Limlengco Enriquez, Makati City (PH)

Correspondence Address: INTELLECTUAL PROPERTY LAW GROUP LLP, 12 SOUTH FIRST STREET, SUITE 1205, SAN JOSE, CA, 95113, US

(73) Assignee: PAYSETTER PTE LTD, Singapore (SG)

(21) Appl. No.: 11/571,246

(22) PCT Filed: Jun. 21, 2005
(86) PCT No.: PCT/SG05/00203

§ 371 Date: Jun. 3, 2008

(30) Foreign Application Priority Data
Jun. 22, 2004 (SG) 200403791-7

(51) Int. Cl. H04M 3/42

(52) U.S. Cl. 455/406

(57) ABSTRACT

A system (10) for transferring credit between mobile phone subscribers (12) comprising: a telecommunications carrier (16), the telecommunications carrier (16) having a billing system (22); mobile phone subscribers (12), each mobile phone subscriber (12) possessing a mobile phone (18) that communicates using a mobile phone network (20) operated by the telecommunications carrier (16) and thereby having an account (28) with the telecommunication carrier's (16) billing system (22); and a facilitator (14), where a first subscriber (12a) sends a communication message (26) using their mobile phone (18), including identification details of a second subscriber (12b), to a shortcode (24) associated with the facilitator (14) and the facilitator (14), in response to the communication message (26), operates to debit at least an amount associated with the shortcode (24) from the first subscriber's (12a) account (28) with the billing system (22), as identified by the number of the mobile phone (18) used to send the communication message (26), and credit the amount associated with the shortcode (24) to the second subscriber's (12a) account (28) with the billing system (22), as referenced by the identification details included in the communication message (26).

### FIELD OF THE INVENTION

The present invention relates to a system and method for transferring credit between mobile phone subscribers.

### BACKGROUND ART

The following discussion of the background of the invention is intended to facilitate an understanding of the invention. However, it should be appreciated that the discussion is not an acknowledgement or admission that any of the material referred to was published, known or part of the common general knowledge of the person skilled in the art in any jurisdiction as at the priority date of the application.

Existing systems for transferring credit from one mobile phone subscribed to another require the transferring party to send a message to the system identifying the recipient party by their mobile phone number, specifying the amount of money to be transferred and providing some means for verifying authorization of the transaction. However, this can be cumbersome for the transferring party and, therefore, it is an object of the present invention to provide a simplified system of transferring credit between mobile phone subscribers.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of the invention there is provided a system for transferring credit between mobile phone subscribers comprising:
a telecommunications carrier, the telecommunications carrier having a billing system; and
a facilitator,
   where each mobile phone subscriber possesses a mobile phone that communicates using a mobile phone network operated by the telecommunications carrier and where one of the mobile phone subscribers sends a communication message, including identification details of another mobile phone subscriber, to a shortcode associated with the facilitator and the facilitator thereby operates to instruct the billing system to debit an amount associated with the shortcode from an account associated with the mobile phone subscriber and credit an account associated with the other mobile phone subscriber, as referenced by the identification details included in the communication message, with the amount associated with the shortcode.

Preferably, the amount associated with the shortcode forms part of the shortcode.

On completion of a successful transfer of credit, ideally the facilitator sends a communication message to both mobile phone subscribers informing them of the successful transfer. Alternatively, if the transfer of credit is unsuccessful, the facilitator sends a communication message to the mobile phone subscriber who initiated the transfer informing them of the transfer failure and optionally also the problem that caused the transfer to fail.

The facilitator may undertake a check of the amount of credit associated with the initiating mobile phone subscriber to ensure that the subscriber has sufficient credit to effect the transfer. The facilitator may also request the initiating mobile phone subscriber to provide personal information for storing in a customer database. This personal information may include a password or other identifier that must be included in any subsequent communication message sent to the facilitator as a means of initiating a transfer, so as to prove that the subsequent transfer is authorised by the initiating mobile phone subscriber.

The communication message may be an SMS message, MMS message or other similar message capable of transfer via the mobile phone network to the mobile phone subscriber's mobile phones.

In accordance with a second aspect of the invention there is provided a facilitator for use in a system for transferring credit between mobile phone subscribers, where when the facilitator receives a communication message from one of the mobile phone subscribers via a shortcode, the communication message including identification details of another mobile phone subscriber, the facilitator instructs a billing system of a telecommunications carrier who operates a mobile phone network used by the mobile phone subscribers to communicate to debit an amount associated with the shortcode from an account associated with the mobile phone subscriber and instruct the billing system to credit an account associated with the other mobile phone subscriber, as referenced by the identification details included in the communication message, with the amount associated with the shortcode.

Preferably, the amount associated with the shortcode forms part of the shortcode.

In accordance with a third aspect of the invention there is a method of transferring credit between mobile phone subscribers, comprising:
receiving a communication message from one of the mobile phone subscribers via a shortcode, the communication message including identification details of another mobile phone subscriber;
instructing a billing system of a telecommunications carrier who operates a mobile phone network used by the mobile phone subscribers to communicate to debit an amount associated with the shortcode from an account associated with the mobile phone subscriber; and
instructing the billing system to credit an account associated with the other mobile phone subscriber, as referenced by the identification details included in the communication message, with the amount associated with the shortcode.

Preferably, the method further includes the step of parsing the shortcode to determine a payment amount and an access code, the payment amount being the amount associated with the shortcode.

### BRIEF DESCRIPTION OF THE DRAWINGS

The invention will now be described in the context of the following drawings, of which:

FIG. 1 is a schematic representation of a system for transferring credit between mobile phone subscribers.

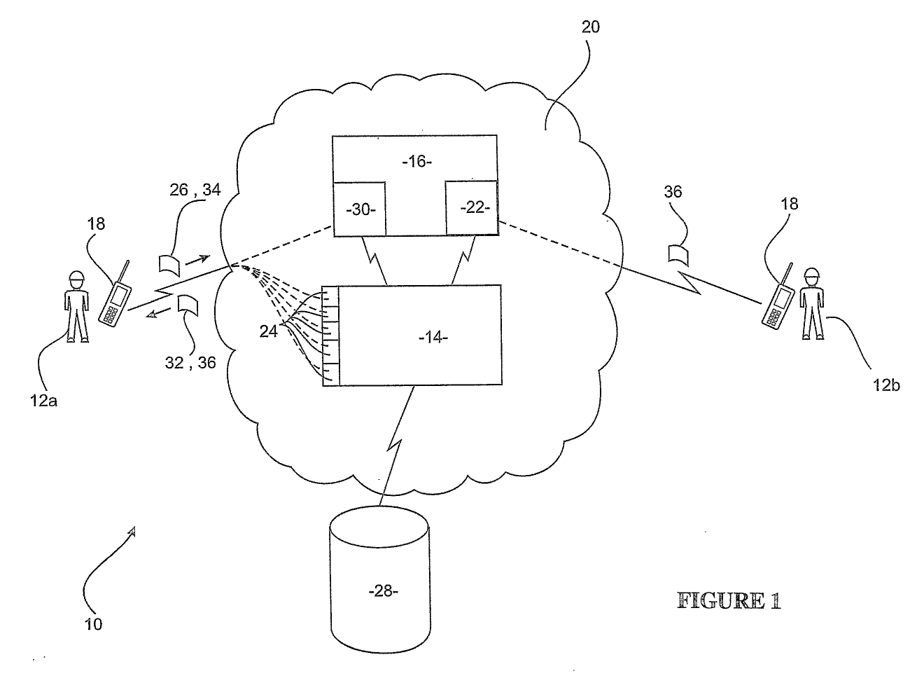

### BEST MODE(S) FOR CARRYING OUT THE INVENTION

In accordance with a first embodiment of the invention there is provide a system 10 for transferring credit between mobile phone subscribers 12a, 12b. In addition to the mobile phone subscribers 12a, 12b (who will hereafter be referred to as the “transferee” and “recipient” respectively), the system 10 also includes a facilitator 14 and a telecommunications carrier 16.

The transferee 12a and the recipient 12b each possess a mobile phone 18. Each mobile phone 18 utilises a mobile phone network 20 of the telecommunications carrier 16 to communicate.

The facilitator 14 is a computer program. The computer program that forms the facilitator 14 executes on a host computer (not shown) operated by the telecommunications carrier 16. The facilitator 14 interfaces with the billing system 22 of the telecommunications carrier 16. The telecommunications carrier 16 also allocates a plurality of shortcodes 24 for use by the facilitator 14.

Ideally, the shortcodes 24 allocated by the telecommunications carrier 16 for use by the facilitator 14 are a combination of:
a denomination commonly transferred between the telecommunications carrier's 16 mobile phone subscribers. In this manner, in situations where the telecommunications carrier's 16 mobile phone subscribers commonly transfer credit amounts that fall within a tight range of denominations, the telecommunications carrier 16 need not give up a large number of shortcodes; and
a common access number.

As a result, the shortcodes 24 can be determined from either of the following formats:
<denomination><access numbers>
   OR
<access number><denomination>

The system 10 will now be described in the context of the following example.

The telecommunications carrier 16 allocates the following shortcodes 24 for use by the facilitator 14:

| | | | |
|---|---|---|---|
| 209999 | 509999 | 999920 | 999950 |

Accordingly, the above shortcodes 24 cover $20 and $50 denominations for the access code 9999.

When the transferee 12a wants to transfer credit to the recipient 12b, the transferee 12a sends an SMS message 26 to one of the shortcodes 24 using mobile phone 18. The shortcode 24 that SMS message 26 is sent to is limited by the denomination that the transferee 12a wishes to credit to the recipient 12b. In the context of the above examples, this means that if the transferee 12a wished to transfer $20 to the recipient, the SMS message 26 must be sent to 209999 or 999920.

SMS message 26 includes the mobile phone number of the mobile phone 18 possessed by recipient 12b.

On receipt of the SMS message 26, the facilitator 14 records the shortcode 24 through which the SMS message 26 has been received, as well as the mobile phone number of the mobile phone 18 possessed by the recipient 12a. Using the recorded mobile phone number as the search criteria, the facilitator 14 searches a customer record database 28 to determine whether the transferee 12a in an existing user of the system 10.

In this example, as the transferee 12a is not an existing user of the system 10, the facilitator 14 issues a command to the SMSC 30 of the mobile phone network 20 to sends a confirmation SMS message 32 to the transferee 12a. The confirmation SMS message 32 asks the transferee 12a to enter a set of registration details and a password for authenticating future transfer requests. The set of registration details and password are then sent as a reply 34 to confirmation SMS message 32.

The facilitator 14, on receipt of reply 34, operates to create a new record in the customer record database 28. The new record includes the registration details and password included in the reply 34. The primary key of the record is the mobile phone number of the mobile phone 18 possessed by the transferee 12a.

While this is occurring, the facilitator 14 also interfaces with the billing system 22 to enquire whether the transferee 12a has sufficient credit accrued to complete the transfer (the determination of credit again being made with reference to the mobile phone number of the mobile phone 18 possessed by the transferee 12a). If the billing system 22 informs the facilitator 14 that there is insufficient credit accrued to the transferee 12a to complete the transfer, the facilitator 14 takes appropriate action to terminate the transfer and inform the transferee 12a of the termination of the transfer. If the billing system 22 informs the facilitator 14 that there is sufficient credit accrued to the transferee 12a to complete the transfer, the facilitator 14:
issues a debit command to debit the denomination (as associated with the shortcode 24 used to send the SMS message 26) from the credit accrued to the transferee 12a;
issue a credit command to credit the denomination (as associated with the shortcode 24 used to send the SMS message 26) to the credit accrued to the recipient 12b. The means of determining the credit accrued to the recipient, and the means of ensuring that the appropriate billing system 22 record is credited, is by means of the mobile phone number of the mobile phone 18 possessed by the recipient 12b and as recorded in SMS message 26; and
generate a trace number.

The facilitator 14 then sends a Transaction SMS message 36 to the mobile phones 18 of both the transferee 12a and recipient 12b. The Transaction SMS message 36 informs both the transferee 12a and recipient 12b of the success of the transfer and the trace number for the transaction.

It should be appreciated that the scope of the invention is not limited to the specific embodiment described herein.

1. A system for transferring credit between mobile phone subscribers comprising:
a telecommunications carrier, the telecommunications carrier having a billing system;
a plurality of mobile phone subscribers, each of said subscribers possessing a mobile phone that communicates using a mobile phone network operated by the telecommunications carrier and thereby having an account with the telecommunication carrier's billing system; and
a facilitator;
wherein the facilitator has at least one shortcode associated therewith, each shortcode being allocated to represent a specific currency amount;
where a first subscriber sends a communication message using their mobile phone, including identification details of a second subscriber, to a said shortcode associated with the facilitator and the facilitator, in response to the communication message, operates to debit at least an amount associated with the shortcode from the first subscriber's account with the billing system, as identified by the number of the mobile phone used to send the communication message, and credit the amount associated with the shortcode to the second subscriber's account with the billing system, as referenced by the identification details included in the communication message.

2. A system according to claim 1, where the amount associated with the shortcode forms part of the shortcode.

3. A system according to claim 1 or 2, where, when a successful transfer of credit has been achieved, the facilitator sends a second communication message to the mobile phone of each of the first subscriber and the second subscriber informing them of the successful transfer.

4. A system according to claim 1 or claim 2, where, when there has been an unsuccessful transfer of credit, the facilitator sends a third communication message to the mobile phone of the first subscriber, the third communication message informing the first subscriber of the unsuccessful transfer.

5. A system according to claim 4 wherein the third communication message also informs the first subscriber of the reason for the unsuccessful transfer.

6. A system according to any one of the preceding claims, where the facilitator checks the amount of credit the first subscriber has in their account with the billing system prior to instructing the billing system to debit at least an amount associated with the shortcode from the first subscriber's account.

7. A system according to any one of the preceding claims, where the facilitator requests the first subscriber to provide personal information for storing in a customer database, at least a subset of the personal information required to be included in any subsequent communication message request to transfer credit as a means of authenticating the transfer.

8. A system according to claim 6 where the personal information includes a password or personal identification number.

9. A facilitator for use in a system for transferring credit between mobile phone subscribers, wherein the facilitator has at least one shortcode associated therewith, each shortcode being allocated to represent a specific amount; where, in response to a communication message sent by a first subscriber using a mobile phone in their possession and received at a said shortcode associated with the facilitator, the facilitator operates to debit at least an amount associated with the shortcode from the first subscriber's account with a billing system of a telecommunications carrier who operates a mobile phone network through which the mobile phone possessed by the first subscriber can communicate, as identified by the number of the mobile phone used to send the communication message, and credit the amount associated with the shortcode to a second subscriber's account with the billing system, as referenced by identification details included in the communication message.

10. A facilitator according to claim 9, where, when a successful transfer of credit has been achieved, the facilitator sends a second communication message to the mobile phone of the first subscriber and a mobile phone of the second subscriber informing them of the successful transfer.

11. A facilitator according to claim 9, where, when there has been an unsuccessful transfer of credit, the facilitator sends a third communication message to the mobile phone of the first subscriber, the third communication message informing the first subscriber of the unsuccessful transfer.

12. A facilitator according to claim 11 wherein said third communication message also informs the first subscriber of the reason for the unsuccessful transfer.

13. A facilitator according to any one of claims 9 to 12, operable to check the amount of credit the first subscriber has in their account with the billing system prior to instructing the billing system to debit at least an amount associated with the shortcode from the first subscriber's account.

14. A facilitator according to any one of claims 9 to 13, operable to request the first subscriber to provide personal information for storing in a customer database, at least a subset of the personal information required to be included in any subsequent communication message request to transfer credit as a means of authenticating the transfer.

15. A method of transferring credit between mobile phone subscribers of a telecommunications carrier comprising the steps of:
providing a facilitator associated with said telecommunications carrier, wherein the facilitator has at least one shortcode associated therewith, each shortcode being allocated to represent a specific currency amount;
receiving a communication message sent by a first subscriber using a mobile phone in their possession at a said shortcode;
debiting at least an amount associated with the shortcode from the first subscriber's account with a billing system of said telecommunications carrier, said first subscriber being identified by the number of the mobile phone used to send the communication message; and
crediting the amount associated with the shortcode to a second subscriber's account with the billing system, as reference by identification details included in the communication message.

16. A method for transferring credit according to claim 15, further including the step of sending a second communication message to the mobile phone of the first subscriber and to a mobile phone of the second subscriber informing them of the successful transfer, when a successful transfer of credit has been achieved.

17. A method for transferring credit according to claim 15, further including the step of sending a third communication message to the mobile phone of the first subscriber informing the first subscriber a transfer failure, when there has been an unsuccessful transfer of credit.

18. A method of transferring credit according to claim 17 wherein the third communication message also informs the first subscriber of the reason for the transfer failure.

19. A method for transferring credit according to any one of claims 15 to 18, further including the step of checking the amount of credit the first subscriber has in their account with the billing system prior to debiting at least an amount associated with the shortcode from the first subscriber's account.

20. A method of transferring credit according to any one of claims 15 to 19, further including the step of requesting the first subscriber to provide personal information for storing in a customer database, at least a subset of the personal information required to be included in any subsequent communication message request to transfer credit as a means of authenticating the transfer.

21. A method of transferring credit according to claim 20, where the personal information includes a password or personal identification number.

22. A computer readable medium having computer software recorded thereon for transferring credit between mobile phone subscribers, the software comprising:
means for receiving a communication message sent by a first subscriber using a mobile phone in their possession at least one shortcode, each shortcode being allocated to represent a specific currency amount;
means for debiting at least an amount associated with the shortcode from the first subscriber's account with a billing system of a telecommunications carrier who operates a mobile phone network used by the mobile phone to communicate, as identified by the number of the mobile phone used to send the communication message; and
means for crediting the amount associated with the shortcode to a second subscriber's account with the billing system, as reference by identification details included in the communication message.

23.-25. (canceled)
